(19) United States
(12) Patent Application Publication
(10) Pub. No.: US 2024/0179480 A1
(43) Pub. Date: May 30, 2024

(54) METHOD FOR TRAINING A SPEAKER RECOGNITION UNIT OF A HEARING AID AND COMBINATION OF SUCH A HEARING AID AND A COMMUNICATION DEVICE

(71) Applicant: Sivantos Pte. Ltd., Singapore (SG)

(72) Inventors: Christoph Lüken, Erlangen (DE); Matthias Müller-Wehlau, Erlangen (DE); Niklas Harlander, Erlangen (DE)

(21) Appl. No.: 18/517,291

(22) Filed: Nov. 22, 2023

(30) Foreign Application Priority Data
Nov. 24, 2022 (DE) 10 2022 212 578.9

(51) Int. Cl. H04R 25/00; G10L 15/02; G10L 15/06; G10L 15/08

(52) U.S. Cl. CPC H04R 25/554; G10L 15/02; G10L 15/063; G10L 15/083; H04R 25/40; G10L 2015/0638; H04R 2225/39; H04R 2225/61

(57) ABSTRACT

A method trains a speaker recognition unit of a hearing aid of a user, wherein the hearing aid is connected to a communication device of the user, for carrying out a remote conversation between the user of the hearing aid and a conversation partner of the user. An audio signal of the conversation partner is received by the communication device for output to the user. A speaker ID is assigned to the conversation partner, wherein a number of speech samples of the conversation partner is extracted from the audio signal. The speech samples are assigned to the speaker ID and form a training data set jointly therewith. The speaker recognition unit of the hearing aid is trained using the training data set in order to recognize the conversation partner in future.

### CROSS-REFERENCE TO RELATED APPLICATION

This application claims the priority, under 35 U.S.C. § 119, of German Patent Application DE 10 2022 212 578.9, filed Nov. 24, 2022; the prior application is herewith incorporated by reference in its entirety.

### FIELD AND BACKGROUND OF THE INVENTION

The invention relates to a method for training a speaker recognition unit of a hearing aid and a hearing aid and a communication device which are configured to carry out such a method in combination.

A hearing aid generally has an input transducer, a signal processing unit, and an output transducer. The input transducer is typically a microphone. The output transducer is typically a receiver, which is also referred to as a loudspeaker. A hearing aid is generally assigned to a single user and is only used by this user. A hearing aid is used, for example, to treat a hearing-impaired user and to compensate for a hearing loss. The input transducer generates an input signal which is fed to the signal processing unit. The signal processing unit modifies the input signal and thus generates an output signal, which is thus a modified input signal. To compensate for a hearing loss, the input signal is amplified, for example, according to an audiogram of the user using a frequency-dependent amplification factor. The output signal is finally output to the user by means of the output transducer. In a hearing aid having microphone and receiver, the microphone accordingly generates the input signal from sound signals in the surroundings and the receiver in turn generates a sound signal from the output signal. The input signal and the output signal are electrical signals which are therefore also each referred to in short as a signal. The sound signals of the surroundings and the sound signal possibly output by the receiver are acoustic signals, in contrast.

A speaker recognition unit is used to identify a speaker (“speaker recognition”). This means the specific identification of a certain person and not the detection of the presence of a speaker as such (“speaker detection”), the detection of the presence of speech as such (“speech detection”), or the recognition of what is spoken (“speech recognition”). In the case of speaker recognition, a speaker is identified on the basis of their speech. Speaker recognition is possible since each person has an individual pronunciation, so that their speech has characteristic features by means of which the speech of this person is distinguishable from the speech of another person.

However, one problem in speaker recognition is that it has to be trained in order to be able to recognize one or more speakers at all. The characteristic features of the speech of that speaker who is to be recognizable have to be taught to the speech recognition unit. This generally requires corresponding effort, namely carrying out training.

### SUMMARY OF THE INVENTION

Against this background, it is the object of the invention to improve, in particular to simplify, the training of a speaker recognition unit. The speaker recognition unit is moreover to be integrated into a hearing aid so that it is then controllable depending on the speaker. The training is to involve as little effort as possible for a user of the hearing aid. At the same time, the speaker recognition unit is to be trained as much as possible with regard to the individual need of the user, i.e., especially to recognize those persons who are actually possible conversation partners of the user.

Reference is made to published, non-prosecuted German patent application DE 10 2019 219 567 A1, corresponding to U.S. patent publication No. 20210183363.

The object is achieved according to the invention by a method having the features as claimed in the independent method claim and by a hearing aid and a communication device as claimed in the independent hearing aid and communication device claim. The object is also achieved in particular by a hearing aid alone, which is designed to carry out the method. Advantageous embodiments, refinements, and variants are the subject matter of the dependent claims. The statements in conjunction with the method also apply accordingly to the hearing aid and the communication device. Insofar as steps of the method are described explicitly or implicitly hereinafter, advantageous embodiments result for the hearing aid and the communication device in particular in that they are designed to carry out one or more of these steps, wherein the allocation of the steps to the hearing aid and the communication device is initially primarily arbitrary. The hearing aid and the communication device each in particular have a suitable control unit for carrying out one or more steps and the method as such.

With the foregoing and other objects in view there is provided, in accordance with the invention, a method for training a speaker recognition unit of a hearing aid of a user. The method includes connecting the hearing aid to a communication device of the user, for carrying out a remote conversation between the user of the hearing aid and a conversation partner of the user. An audio signal of the conversation partner is received by the communication device for output to the user. A speaker ID is assigned to the conversation partner. A number of speech samples of the conversation partner are extracted from the audio signal. The speech samples are assigned to the speaker ID and form a training data set jointly therewith. The speaker recognition unit of the hearing aid is trained using the training data set in order to recognize the conversation partner in a future conversation. The speaker ID is determined by means of a contact directory, in which the speaker ID and an item of contact information for establishing a remote conversation are stored in each case for a number of possible conversation partners.

The method is used for training a speaker recognition unit of a hearing aid of a user. The training takes place in particular in the operation of the hearing aid, i.e., during the intended use by the user of the hearing aid. The training is insofar also a part of a method for operating the hearing aid.

The hearing aid is connected to a (first) communication device of the user, for carrying out a remote conversation between the user of the hearing aid and a conversation partner of the user. The hearing aid and the communication device are both in particular personal devices of the same user. “Remote conversation” is understood in particular to mean that sound signals of the conversation partner do not reach the hearing aid and the user directly, but rather a conversion into an audio signal (i.e., an electrical signal which contains audio data) for the purpose of transmission and subsequent conversion back into a sound signal for the user are necessary. The transmission generally takes place here over large distances. The remote conversation is, for example, a telephone call. The communication device is suitably a telephone, such as a smart phone, or in general a device having a telephone function. In particular a (second) communication device is likewise provided on the part of the conversation partner, the statements on the communication device of the user apply accordingly. The two communication devices do not necessarily have to be designed identically here, however.

The hearing aid and the first communication device are preferably two separate devices, which are also usable and functional independently of one another. However, an embodiment in which the first communication device is integrated into the hearing aid is also suitable.

In the scope of the method (and specifically in case of a remote conversation), in a first step, an audio signal of the conversation partner is received by the communication device for output to the user. The remote conversation is accordingly implemented in particular in that a sound signal, especially having speech of the conversation partner, is received using the second communication device of the conversation partner and converted into an audio signal, which is then transmitted to the first communication device of the user. Alternatively, the second communication device receives a corresponding audio signal directly and the conversion of the sound signals of the conversation partner into such an audio signal takes place using another device, such as a headset or a hearing aid. On the side of the user, the output of the audio signal preferably takes place by means of the hearing aid, i.e., the first communication device transmits the audio signal to the hearing aid and it converts the audio signal into a sound signal for output to the user. The above-mentioned statements apply analogously in the reverse direction, i.e., for the transmission of a sound signal having speech of the user to the conversation partner; however, this channel is not necessarily important in the present case. The details of the conversion and transmission are also not important in the present case. An “audio signal” is understood in general as an electrical signal which contains audio data. The audio signal is transmitted to the first communication unit, for example, via a telecommunication network, e.g., fixed network, mobile wireless network, Internet, or the like or a combination thereof. The audio signal is then preferably transmitted from the first communication device to the hearing aid and output thereby, in particular as a sound signal. The transmission of the audio signal from the communication device of the user to the hearing aid in particular takes place wirelessly, preferably via a Bluetooth connection or alternatively via another radio connection.

In addition, in a second step, a speaker ID is assigned to the conversation partner. In other words: the conversation partner is identified, which does not mean that the conversation partner is identified on the basis of the speech samples, however, as generally takes place in operation by the speaker recognition unit, but rather that the conversation partner is identified actually and in a way other than by the speech samples. This assignment of the speaker ID to the conversation partner in particular also only takes place in case of a remote conversation. The speaker ID is, for example, simply a name of the conversation partner, however, a pseudonym or a simple number or character chain is also suitable. The speaker ID is in particular uniquely assigned to the conversation partner.

A number of speech samples of the conversation partner is extracted from the audio signal in a third step. “A number” is generally understood as “at least one”. Typically, multiple speech samples are extracted. The mentioned extraction in particular also only takes place in case of a remote conversation, since only then is a corresponding audio signal provided. The speech samples are extracted, for example, in that initially those signal sections are identified in the audio signal by means of a speaker recognition unit which contain speech, and in that these signal sections are then stored as speech samples. The speech samples are then also assigned to the speaker ID and form a training data set jointly therewith.

Using this training data set, the speaker recognition unit of the hearing aid is now trained in a fourth step in order to recognize the conversation partner in future, in particular during the intended use of the hearing aid. The speaker recognition unit trained in this way is now designed to recognize the conversation partner, and advantageously to do so both in a further remote conversation and also outside such a remote conversation, in particular in a real conversation environment, in which the conversation partner is in the vicinity of the user and the speech of the conversation partner does not reach the user via the communication device, but rather is recorded and reproduced directly using the hearing aid. Such a real conversation environment results, for example, during a conversation from face to face. The conversation partner, using whose speech samples and speaker ID the speaker recognition unit was trained as described, is then a trained conversation partner, also referred to as a known or recognizable conversation partner.

The core of the invention presented here are in particular the described extraction of speech samples from an audio signal of a remote conversation and the formation of a training data set therewith and the use of this training data set for training the speaker recognition unit. In contrast, the details of the training itself and the processing of the speech samples performed in this case are of subordinate importance—and are therefore also not described further here. The training can thus be carried out by the hearing aid alone or by the communication device alone or can be distributed onto both. For example, software is installed on the communication device, which analyzes the speech samples and then as a result thereof creates a simple parameter set, feature set, or a model, which is then transmitted to the speaker recognition unit, so that it is then trained accordingly and therefore can recognize the conversation partner in future. The actual speaker recognition in operation of the hearing aid is also of subordinate importance, i.e., how the speaker recognition unit analyzes an audio signal and on the basis thereof recognizes the conversation partner (e.g., by means of GMM, HMM, DNN, etc.).

The hearing aid generally has in particular an input transducer, a signal processing unit, and an output transducer. The input transducer is preferably a microphone. The output transducer is preferably a receiver, which is also referred to as a loudspeaker. The hearing aid is generally assigned to a single user and is only used by this user. The hearing aid is in particular individually adapted to the user. The hearing aid is used in particular to compensate for a hearing loss of the user, i.e., to treat a hearing-impaired user. The input transducer generates an input signal which is fed to the signal processing unit. The signal processing unit modifies the input signal and thus generates an output signal, which is thus a modified input signal. To compensate for a hearing loss, the input signal is amplified, for example, according to an audiogram of the user using a frequency-dependent amplification factor. The output signal is finally output to the user by means of the output transducer. In a hearing aid having microphone and receiver, which is presumed in the present case without restriction of the generality, the microphone accordingly generates the input signal from sound signals in the surroundings and the receiver in turn generates a sound signal from the output signal. The input signal and the output signal are audio signals, i.e., electrical signals. The sound signals of the surroundings and the sound signal possibly output by the receiver are acoustic signals, in contrast.

The speaker recognition unit is used to recognize a speaker (also referred to as “speaker recognition”), in the present case in particular to recognize a conversation partner of the user. This relates to the specific identification of a certain person and not the recognition of the presence of a speaker as such (“speaker detection”), the detection of the presence of speech as such (“speech detection”), or the recognition of what is spoken (“speech recognition”). In the case of speaker recognition, a speaker is identified on the basis of their speech. In this case, the term “speech” means those sound signals which are output by a person when speaking. Speaker recognition is possible since each person has an individual pronunciation, so that their speech has characteristic features by means of which the speech of this person is distinguishable from the speech of another person. Such checking and distinguishing with the result of recognition of a specific speaker is carried out in the present case using the speaker recognition unit. For this purpose, it has a classifier in particular, which searches a given audio signal for certain features (volume, frequency components, timing, etc.), which characterize the speech of a respective conversation partner. If the features of the speech of a trained conversation partner are contained in the audio signal, this conversation partner is recognized. How the conversation partner is then referred to is arbitrary in principle, it is primarily only important that it is recognized that a certain conversation partner speaks, so that suitable measures can be taken in dependence thereon. Such measures are in particular optimized setting of the hearing aid or especially an adaptation of the modification of the input signal by the signal processing unit, for example, to make the conversation partner better audible for the user.

One essential advantage of the invention is in particular that the training for the speaker recognition unit does not require active intervention of the user, but rather takes place solely passively. This is based on the consideration that training for a speaker recognition unit typically requires an active learning phase, which has to be activated actively by the user and during which the future conversation partner to be recognized has to cooperate in order to work through a prescribed procedure for the training. One special problem in hearing aids is that often sufficiently many speech samples of a possible individual conversation partner of the user are not available. These problems are solved in the present case by the described extraction of speech samples during a remote conversation. Moreover, this extraction advantageously takes place completely passively, a special action or cooperation of the conversation partner or the user and also a special environment and procedure for the training are not necessary. The speech recognition unit is rather advantageously trained automatically in the present case in regular operation of the hearing aid, so to speak in the background.

The assignment of the conversation partner to the speech samples is important for the training of the speaker recognition unit, since this enables the future recognition of the conversation partner on the basis of their speech at all for the first time. In the present case, the speaker ID is used for this purpose. If an audio signal is then analyzed by the speaker recognition unit in future, the associated speaker ID—if present—is accordingly returned thereby. This is then, for example, simply displayed to the user and/or a specific configuration of the hearing aid is stored for this speaker ID, which is then set.

In the present case, the fact is utilized for the determination of the speaker ID that in the case of a remote conversation a speaker ID is typically already provided for the conversation partner, which is used at least once to establish the remote conversation at all. The speaker ID is accordingly determined by means of a contact directory, in which a speaker ID and an item of contact information to establish a remote conversation are each stored for a number of possible conversation partners. In this way, the conversation partner is actually identified in a different way than by the speech samples. The combination of speaker ID and contact information is also referred to as a contact or contact entry. In one preferred embodiment, the contact directory is a telephone book which is in particular stored on the communication device. Using the contact directory, it is possible for the user to select a conversation partner and establish a remote conversation with them (or vice versa, the user is contacted by the conversation partner). Accordingly, the conversation partner is then automatically known for this remote conversation and also uniquely identifiable on the basis of the speaker ID. Therefore, this speaker ID is then advantageously assigned to the speech samples which are extracted during the remote conversation. In this way, the actual and correct conversation partner is automatically assigned to the speech samples. If the conversation partner is not known, thus is not stored in the contact directory, consequently training also does not take place. Alternatively, in this case the user is prompted to input a speaker ID, which is then assigned to the speech samples, or a pseudonym, a random ID, or the like is used as the speaker ID.

The present invention accordingly uses the knowledge of the conversation partner and their speaker ID in the special case of a remote conversation to assign the correct speaker ID to the speech samples. An identification of the conversation partner by means of the speaker recognition unit does not necessarily take place here, this is something different. The core of the present invention is the creation of training data sets with reliably correct assignment of speaker ID and speech samples. This is then also in contrast to published non-prosecuted German patent application DE 10 2019 219 567 A1, which was mentioned at the outset. In any case a speaker ID which is assigned to the extracted speech samples is not taken from a contact directory therein.

Selective training only for certain conversation partners, in particular those who were previously selected by the user, is also expedient. In one suitable embodiment for this purpose, a list (so to speak a training plan) is provided, which contains a number of speaker IDs for which the speaker recognition unit is to be trained. The list in particular differs from the contact directory already mentioned. For example, in the contact directory, individual conversation partners and/or groups of conversation partners are selectable, for which the speaker recognition unit is to be trained and which then form the list, so to speak as a subset of the contact directory. The speaker recognition unit is now only trained when the speaker ID of the conversation partner in the (current) remote conversation is contained in the list. In this way, training only takes place for preselected persons and/or groups. Optionally, speech samples are not even extracted and/or a training data set is not even generated if the speaker ID is not contained in the list. The list is stored, for example, on the hearing aid or the communication device. The list can also be integrated into the contact directory.

The quality of the speech samples is typically sufficient in the case of current technologies for remote conversations for successful training of the speaker recognition unit. Nonetheless, it is expedient to determine the quality of the speech samples and if necessary to discard those speech samples which do not meet a minimum requirement with respect to the quality, i.e., not to use them for training the speaker recognition unit. In one suitable embodiment for this purpose, a quality parameter (i.e., the quality in general) of the remote conversation is determined and therefore in particular the quality of possible speech samples which are extractable is also automatically determined. The speaker recognition unit is now only trained when the quality parameter exceeds a specified limiting value (upward or downward depending on the embodiment). It is also true here that speech samples are optionally also not even extracted at all and/or a training data set is not even generated at all if the quality parameter does not exceed the limiting value. The quality parameter is, for example, a bandwidth of the audio signal which is transmitted from the conversation partner (especially their communication device) to the communication device of the user. Alternatively, the quality parameter is a connection quality of the connection between the two communication devices for the remote conversation. It is also possible that first the speech samples are extracted and then the quality parameter is determined on the basis thereof, possibly even separately for each individual speech sample.

The hearing aid preferably has a microphone and is designed to also recognize the conversation partner if their speech is recorded directly by the microphone, i.e., in particular during a conversation from face to face in contrast to a remote conversation. A sound signal which contains the speech of the conversation partner is recorded by the microphone and converted into an input signal. The input signal of the microphone is an audio signal which, like the audio signal during the remote conversation, is accessible to an analysis by the speaker recognition unit. The input signal is accordingly fed to the speaker recognition unit and analyzed thereby. If the current conversation partner corresponds to a trained conversation partner, this is also recognized by the speaker recognition unit. The input signal is in particular also fed to the signal processing unit as already described in order to generate an output signal.

For the remote conversation, the hearing aid is expediently designed to be used as a headset, i.e., as an acoustic input and output device for the communication device of the user. In one suitable embodiment for this purpose, the hearing aid has a headset mode in which the hearing aid is used as an input and output device for sound signals, which are exchanged (i.e., transmitted and/or received) with the conversation partner by the hearing aid in the form of audio signals via the communication device. The headset mode is activated in particular during a remote conversation. The communication device of the user is used in particular in this case as a relay for relaying audio signals between the hearing aid of the user and the communication device of the conversation partner. Overall, a headset mode-based training for the speaker recognition is then implemented thereby.

The hearing aid in general and especially in particular the generation of the output signal by means of the signal processing unit are expediently controlled depending on the speaker, i.e., depending on the speaker ID of the conversation partner recognized in a now real conversation environment on the basis of the preceding training. Several suitable embodiments for such a speaker-dependent adaptation of the operation of the hearing aid upon recognizing the conversation partner by means of the speaker recognition unit are described hereinafter. It is presumed here that the recognition takes place in a real conversation environment, i.e., the speech of the conversation partner reaches the hearing aid directly as a sound signal and not via the detour of a communication device and in the form of an audio signal, although this is possible in principle. The mentioned embodiments are also combinable with one another.

In a first embodiment, upon recognition of the conversation partner by means of the speaker recognition unit, the operation of the hearing aid is adapted depending on the speaker in that a hearing direction of the hearing aid is directed, in particular focused, toward the conversation partner. The hearing aid is operated in this case in particular in an operating mode “directional hearing”, for which the microphone is designed as a directional microphone in order to highlight sound signals from a specific direction in relation to sound signals from other directions. This specific direction is determined by a directional characteristic of the microphone which is now set such that it highlights the recognized conversation partner in relation to other sound sources in the surroundings.

In a second embodiment, upon recognition of the conversation partner by means of the speaker recognition unit, the operation of the hearing aid is adapted depending on the speaker in that a sound profile or operating program of the hearing aid assigned to the conversation partner is set. The operation of the hearing aid, in particular processing of the input signal by means of the signal processing unit, is thus specially adapted to the conversation partner. For example, the conversation partner generally speaks particularly quietly and a sound profile is then stored using which the signal processing unit uses a greater amplification factor than is specified by the audiogram. It is also conceivable that the headset mode is activated for a specific conversation partner if they also have a hearing aid which is also switched into a headset mode in order to then communicate directly by means of audio signals.

In a third embodiment, upon recognition of the conversation partner by means of the speaker recognition unit, the operation of the hearing aid is adapted depending on the speaker in that a media playback is interrupted which takes place via the hearing aid. The condition for this is that a media playback is active at all at this point in time. Similarly to the headset mode, the hearing aid is also operable solely as an audio output device in a media playback mode. If this is active and the conversation partner is recognized, the media playback mode is interrupted so that the user can better understand the conversation partner. This is particularly reasonable in combination with the above-mentioned list of conversation partners for which the speaker recognition unit is activated at all, so that then also the media playback is interrupted especially only for this—possibly particularly relevant—conversation partner.

In a fourth embodiment, upon recognition of the conversation partner by means of the speaker recognition unit, the operation of the hearing aid is adapted depending on the speaker in that a silent operation of the hearing aid is deactivated. The condition for this is that the silent operation is active at all at this point in time. In silent operation, for example, ambient noise suppression or noise suppression is activated. The statements and advantages on the third embodiment above fundamentally apply analogously for this purpose.

In a fifth embodiment, upon recognition of the conversation partner by means of the speaker recognition unit, the operation of the hearing aid is adapted depending on the speaker in that a preprocessing unit of the hearing aid is activated, in particular for speech recognition. The preprocessing unit implements optional preprocessing of the input signal from the microphone, in particular before the input signal is further processed. For example, the hearing aid has a speech recognition unit by means of which speech is recognized in particular in parallel to and fundamentally independently of the signal processing unit. For this purpose, preprocessing before the speech recognition unit is advantageous, for example, to deliberately isolate speech components. This is carried out by means of the preprocessing unit, the activation of which is only required, however, if speech or special speech which is also actually to be recognized is also present.

Other features which are considered as characteristic for the invention are set forth in the appended claims.

Although the invention is illustrated and described herein as embodied in a method for training a speaker recognition unit of a hearing aid and a combination of such a hearing aid and a communication device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a flow chart showing a method of training a speaker recognition unit of a hearing aid;

FIG. 2 is a block diagram of a hearing aid and a communication device;

FIG. 3 is an illustration of a remote conversation between a user and a conversation partner; and

FIG. 4 is an illustration of a user and a conversation partner from FIG. 2 in a real conversation environment.

### DETAILED DESCRIPTION OF THE INVENTION

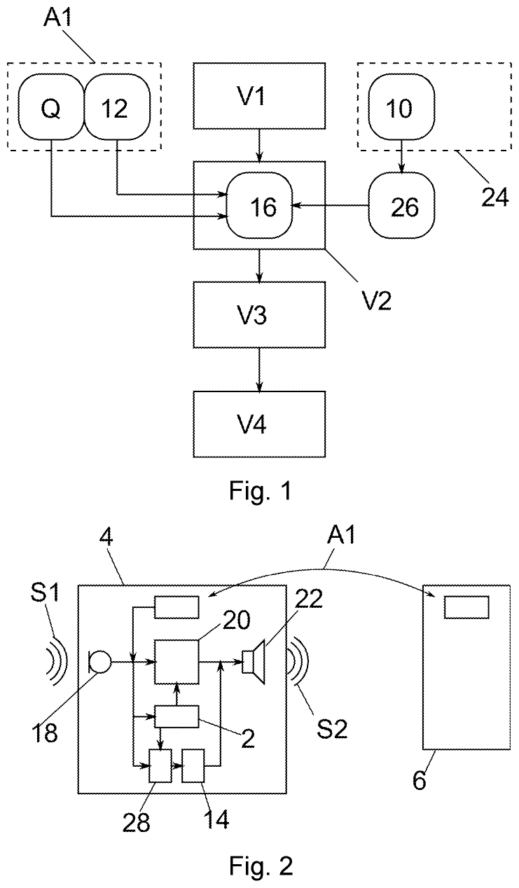

Referring now to the figures of the drawings in detail and first, particularly to FIG. 1 thereof, there is shown an exemplary method for training a speaker recognition unit 2 of a hearing aid 4 of a user N. The training takes place in operation of the hearing aid 4, i.e., during the intended use by the user N. The training is insofar also a part of a method for operating the hearing aid 4.

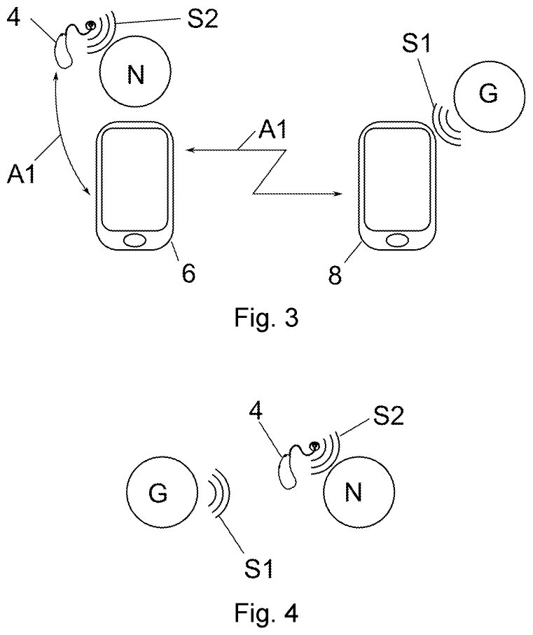

The hearing aid 4 is connected to a (first) communication device 6 of the user N, to carry out a remote conversation between the user N and a conversation partner G of the user N. The hearing aid 4 and the communication device 6 are both personal devices of the same user N, an exemplary embodiment for these two devices is shown in FIG. 2. “Remote conversation” is understood in the present case to mean that sound signals S1 of the conversation partner G do not reach the hearing aid 4 and the user N directly, but rather a conversion into an audio signal A1 (i.e., an electrical signal which contains audio data) for the purpose of transmission and a subsequent conversion back into a sound signal S2 for the user N are required. This is illustrated by way of example in FIG. 3, the remote conversation is a telephone call there and the communication device 6 is a telephone. A (second) communication device 8 is also provided on the side of the conversation partner G in FIG. 3, the statements on the communication device 6 of the user N apply accordingly. The two communication devices 6, 8 do not necessarily have to be configured identically. In the exemplary embodiment shown here, the hearing aid 4 and the first communication device 6 are two separate devices, which are also usable and functional independently of one another. However, an embodiment (not explicitly shown) is also suitable in which the first communication device 6 is integrated into the hearing aid 4.

In the scope of the method, in a first step V1, the audio signal A1 of the conversation partner G is received by the communication device 6 for output to the user N. The remote conversation is accordingly implemented in FIG. 3 in that a sound signal, especially having speech of the conversation partner G, is recorded using the second communication device 8 of the conversation partner G and converted into an audio signal A1, which is then transmitted to the first communication device 6 of the user N. On the side of the user N, the output of the audio signal A1 in FIG. 3 takes place by means of the hearing aid 4, i.e., the first communication device 6 transmits the audio signal A1 to the hearing aid 4 and it converts the audio signal A1 into a sound signal S2 for output to the user N. “Audio signal” is understood in general as an electrical signal which contains audio data. The audio signal A1 is transmitted to the first communication device 6, for example, via a telecommunication network. The transmission of the audio signal A1 from the communication device 6 to the hearing aid 4 takes place wirelessly in FIG. 3, for example, via a Bluetooth connection.

In addition, in a second step V2, a speaker ID 10 is assigned to the conversation partner G. In other words: the conversation partner G is identified. The speaker ID 10 is, for example, simply a name of the conversation partner G, however, a pseudonym or a simple number or character chain is also suitable. The speaker ID 10 is uniquely assigned to the conversation partner G.

In a third step V3, a number of speech samples 12 of the conversation partner G is extracted from the audio signal A1. “A number” is understood in general as “at least one”. Multiple speech samples 12 are typically extracted. The speech samples 12 are extracted, for example, in that initially those signal sections which contain speech are recognized in the audio signal A1 by means of a speech recognition unit 14, and in that these signal sections are then stored as speech samples 12. The speech samples 12 are then also assigned to the speaker ID 10 and form a training data set 16 together therewith.

In a fourth step V4, the speaker recognition unit 10 of the hearing aid 4 is now trained using this training data set 16, in order to recognize the conversation partner G in future. The speaker recognition unit 10 trained in this manner is now designed to recognize the conversation partner G in a real conversation environment as shown by way of example in FIG. 4. In such a real conversation environment, the conversation partner G is in the vicinity of the user N and the speech of the conversation partner G, i.e., the sound signal S1, does not reach the user N via the communication device 6, but rather is recorded and reproduced directly using the hearing aid 4. Such a real conversation environment results, for example, during a conversation from face to face. The conversation partner G, using whose speech samples 12 and speaker ID 10 the speaker recognition unit 2 was trained as described, is then a trained conversation partner G, also referred to as a known or recognizable conversation partner G.

The hearing aid 4 has, in FIG. 2, an input transducer 18, a signal processing unit 20, and an output transducer 22. The input transducer 18 is a microphone here, the output transducer 22 is a receiver here. The hearing aid 4 is assigned to a single user N and is only used by them and is individually adapted to them. The hearing aid 4 is used to compensate for a hearing loss of the user N. The input transducer 18 generates an input signal, which is supplied to the signal processing unit 20, from the sound signal S1. The signal processing unit 20 modifies the input signal and thus generates an output signal, which is therefore a modified input signal. To compensate for hearing loss, the input signal is amplified, for example, according to an audiogram of the user N using a frequency-dependent amplification factor. The output signal is finally output by means of the output transducer 22 to the user N, namely as the sound signal S2.

The speaker recognition unit 2 is used to recognize a speaker (“speaker recognition”), in the present case especially to recognize the conversation partner G of the user N. In the case of speaker recognition, a speaker is identified on the basis of their speech. The term “speech” in this case means those sound signals S1 which are output by a person when speaking. A speaker recognition is possible since each person has an individual pronunciation, so that their speech has characteristic features by means of which the speech of this person is distinguishable from the speech of another person. Such a check and distinction with the result of a recognition of a certain speaker is carried out in the present case using the speaker recognition unit 2. This has for this purpose, for example, a classifier, which searches a given audio signal A1 for specific features, which characterize the speech of a respective conversation partner G. If the features of the speech of a trained conversation partner G are contained in the audio signal A1, this conversation partner G is recognized. How the conversation partner G is then referred to is arbitrary in principle, it is initially only important that it is recognized that a specific conversation partner G speaks, so that suitable measures can be taken depending thereon. Such measures are, for example, an optimized setting of the hearing aid 4 or an adaptation of the modification by the signal processing unit 20, for example, to make the conversation partner G better audible for the user N.

The training described here for the speaker recognition unit 2 does not require active intervention of the user N, but rather takes place only passively. The described extraction of speech samples 12 triggered during a remote conversation takes place completely passively, a special action or cooperation of the conversation partner G or the user N and also a special environment and procedure for the training are not necessary. The speaker recognition unit 2 is rather automatically trained in regular operation of the hearing aid 4, so to speak in the background.

The assignment of the conversation partner G to the speech samples 12 is important for the training of the speaker recognition unit 2, since this makes the future recognition of the conversation partner G on the basis of their speech possible for the first time at all. In the present case, the speaker ID 10 is used for this purpose. If an audio signal A1 is then analyzed in future by the speaker recognition unit 2, the associated speaker ID 10 is accordingly returned thereby.

In the exemplary embodiment of FIG. 1 shown here, the fact is utilized to determine the speaker ID 10 that during a remote conversation a speaker ID 10 is typically already provided for the conversation partner G, which is initially used once to establish the remote conversation at all. The speaker ID 10 is accordingly determined by means of a contact directory 24 in which a speaker ID 10 and an item of contact information for establishing a remote conversation are stored for each of a number of possible conversation partners G. The contact directory 24 is a telephone book here by way of example, which is stored on the communication device 6. Using the contact directory 24, it is possible for the user N to select a conversation partner G and establish a remote conversation with them (or vice versa, the user N is contacted by the conversation partner G). Accordingly, the conversation partner G is then automatically known for this remote conversation and also uniquely identifiable on the basis of the speaker ID 10. The speaker ID 10 is therefore then assigned to the speech samples 12 which are extracted during the remote conversation. In this manner, the correct conversation partner G is automatically assigned to the speech samples 12.

Selective training only for certain conversation partners G is also expedient, for example, those who were previously selected by the user N. A list 26 is provided for this purpose in FIG. 1, which contains a number of speaker IDs 10, for which the speaker recognition unit 2 is to be trained. The list 26 differs from the above-mentioned contact directory 24. For example, individual conversation partners G and/or groups of conversation partners G are selectable in the contact directory 24, for which the speaker recognition unit 2 is to be trained and which then form the list 26. The speaker recognition unit 2 is now only trained when the speaker ID 10 of the conversation partner G in the current remote conversation is contained in the list 26. In this manner, training is only carried out for preselected persons and/or groups. The list 26 is, for example, stored on the hearing aid 4 or the communication device 5. The list can also be integrated into the contact directory 24.

The quality of the speech samples 12 is typically sufficient with present technologies for remote conversations for successful training of the speaker recognition unit 2. Nonetheless, it is expedient to determine the quality of the speech samples 12 and if necessary discard those speech samples 12 which do not meet a minimum requirement with respect to the quality, i.e., not to use them for training the speaker recognition unit 2. In a suitable embodiment for this purpose, a quality parameter Q (i.e., the quality in general) of the remote conversation is determined and therefore the quality of possible speech samples 12 which are extractable is also determined automatically. The speaker recognition unit 2 is now only trained if the quality parameter Q exceeds a predetermined limiting value (upward or downward depending on the embodiment). The quality parameter Q is, for example, a bandwidth of the audio signal A1 which is transmitted to the communication device 6. It is also possible that first the speech samples 12 are extracted and then the quality parameter Q is determined on the basis thereof, possibly even separately for each individual speech sample 12.

As already described in conjunction with FIG. 2, the hearing aid 4 has a microphone. The hearing aid 4 is then furthermore designed to recognize the conversation partner G even if their speech is recorded directly by the microphone, i.e., during a conversation from face to face, for example, as shown in FIG. 4, in contrast to a remote conversation as shown in FIG. 3. A sound signal S1 which contains speech of the conversation partner G is recorded by the microphone and converted into an input signal. The input signal of the microphone is an audio signal which is accessible like the audio signal A1 during the remote conversation to analysis by the speaker recognition unit 2. Accordingly, the input signal is fed to the speaker recognition unit 2 and analyzed thereby. If the current conversation partner G corresponds to a trained conversation partner G, this is also recognized by the speaker recognition unit 2. The input signal is also fed as already described to the signal processing unit 20 in order to generate an output signal.

For the remote conversation, the hearing aid 4 shown here is configured to be used as a headset, i.e., as an acoustic input and output device for the communication device 6 of the user N. For this purpose, the hearing aid 4 has a headset mode in which the hearing aid 4 is used as an input and output device for sound signals S1, S2, which are exchanged (i.e., transmitted and/or received) by the hearing aid 4 in the form of audio signals A1 via the communication device 6 with the conversation partner G. The headset mode is activated during a remote conversation, thus also in the remote conversation shown in FIG. 3. The communication device 6 is used in this case as a relay for relaying audio signals A1 between the hearing aid 4 and the communication device 8. Overall, a headset mode-based training for the speaker recognition is therefore then implemented.

The hearing aid 4 in general and especially the generation of the output signal by means of the signal processing unit 20 are now controlled depending on the speaker, i.e., depending on the speaker ID 10 of the conversation partner G recognized on the basis of the preceding training in a now real conversation environment. Several exemplary embodiments of such a speaker-dependent adaptation of the operation of the hearing aid 4 upon recognition of the conversation partner G by means of the speaker recognition unit 2 are described hereinafter. It is presumed here that the recognition takes place in a real conversation environment, for example, as in FIG. 4, i.e., the speech of the conversation partner G reaches the hearing aid 4 directly as the sound signal S1 and not via the detour of a communication device 6 and in the form of an audio signal A1, although this is possible in principle.

In a first embodiment, upon recognition of the conversation partner G by means of the speaker recognition unit 2, the operation of the hearing aid 4 is adapted depending on the speaker in that a hearing direction of the hearing aid 4 is directed onto the conversation partner G. The microphone is configured here as a directional microphone in order to highlight sound signals S1 from a specific direction in relation to sound signals from other directions. This specific direction is determined by a directional characteristic of the microphone, which is now set such that it highlights the recognized conversation partner G in relation to other sound sources in the environment.

In a second embodiment, upon recognition of the conversation partner G by means of the speaker recognition unit 2, the operation of the hearing aid 4 is adapted depending on the speaker in that a sound profile or operating program of the hearing aid 4 assigned to the conversation partner G is set. For example, the processing of the input signal by means of the signal processing unit 20 is thus specially adapted to the conversation partner G.

In a third embodiment, upon recognition of the conversation partner G by means of the speaker recognition unit 2, the operation of the hearing aid 4 is adapted depending on the speaker in that a media playback is interrupted, which takes place via the hearing aid 4. Similarly to the headset mode, the hearing aid 4 is also operable solely as an audio output device in a media playback mode. If this is active and the conversation partner G is recognized, the media playback mode is interrupted so that the user N can better understand the conversation partner G.

In a fourth embodiment, upon recognition of the conversation partner G by means of the speaker recognition unit 2, the operation of the hearing aid 4 is adapted depending on the speaker in that a silent operation of the hearing aid 4 is deactivated. The statements and advantages with respect to the third embodiment apply analogously.

In a fifth embodiment, upon recognition of the conversation partner G by means of the speaker recognition unit 2, the operation of the hearing aid 4 is adapted depending on the speaker in that a preprocessing unit 28, for example, for speech recognition as in FIG. 2, of the hearing aid 4 is activated. The preprocessing unit 28 implements optional preprocessing of the input signal from the microphone before the input signal is further processed. For example, the hearing aid 4 has a speech recognition unit 14, by means of which speech is recognized in parallel to and fundamentally independently of the signal processing unit 20. Preprocessing before the speech recognition unit 14 is advantageous for this purpose, for example, to deliberately isolate speech components. This is carried out by means of the preprocessing unit 28, the activation of which is only required, however, if speech or special speech which is also to be recognized is also actually present.

The following is a summary list of reference numerals and the corresponding structure used in the above description of the invention.

### LIST OF REFERENCE SIGNS

2 speaker recognition unit
4 hearing aid
6 (first) communication device
8 (second) communication device
10 speaker ID
12 speech sample
14 speech recognition unit
16 training data set
18 input transducer (microphone)
20 signal processing unit
22 output transducer
24 contact directory
26 list
28 preprocessing unit
A1 audio signal
G conversation partner
N user
S1 sound signal
S2 sound signal
Q quality parameter
V1 first step
V2 second step
V3 third step
V4 fourth step

1. A method for training a speaker recognition unit of a hearing aid of a user, which comprises the steps of:
connecting the hearing aid to a communication device of the user, for carrying out a remote conversation between the user of the hearing aid and a conversation partner of the user;
receiving an audio signal of the conversation partner by the communication device for output to the user;
assigning a speaker ID to the conversation partner;
extracting a number of speech samples of the conversation partner from the audio signal;
assigning the speech samples to the speaker ID and forming a training data set jointly therewith;
training the speaker recognition unit of the hearing aid using the training data set in order to recognize the conversation partner in a future conversation; and
determining the speaker ID by means of a contact directory, in which the speaker ID and an item of contact information for establishing a remote conversation are stored in each case for a number of possible conversation partners.

2. The method according to claim 1, which further comprises providing a list containing a number of speaker IDs, for which the speaker recognition unit is to be trained, wherein the speaker recognition unit is only trained when the speaker ID is contained in the list.

3. The method according to claim 1, which further comprises determining a quality parameter of the remote conversation, wherein the speaker recognition unit is only trained if the quality parameter exceeds a predetermined limiting value.

4. The method according to claim 1, wherein the hearing aid has a microphone and is configured to also recognize the conversation partner when their speech is recorded directly by the microphone.

5. The method according to claim 1, wherein the hearing aid has a headset mode, in which the hearing aid is used as an input and output device for sound signals, which are exchanged by the hearing aid in a form of audio signals via the communication device with the conversation partner.

6. The method according to claim 1, wherein upon recognition of the conversation partner by means of the speaker recognition unit, an operation of the hearing aid is adapted depending on a speaker in that a hearing direction of the hearing aid is directed onto the conversation partner.

7. The method according to claim 1, wherein upon recognition of the conversation partner by means of the speaker recognition unit, an operation of the hearing aid is adapted depending on a speaker in that a sound profile or operating program of the hearing aid assigned to the conversation partner (G) is set.

8. The method according to claim 1, wherein upon recognition of the conversation partner by means of the speaker recognition unit, an operation of the hearing aid is adapted depending on a speaker in that a media playback is interrupted, which takes place via the hearing aid.

9. The method according to claim 1, wherein upon recognition of the conversation partner by means of the speaker recognition unit, an operation of the hearing aid is adapted depending on a speaker in that a silent operation of the hearing aid is deactivated.

10. The method according to claim 1, wherein upon recognition of the conversation partner by means of the speaker recognition unit, an operation of the hearing aid is adapted depending on a speaker in that a preprocessing unit of the hearing aid is activated.

11. The method according to claim 1, wherein upon recognition of the conversation partner by means of the speaker recognition unit, an operation of the hearing aid is adapted depending on a speaker in that a preprocessing unit, namely for speech recognition, of the hearing aid is activated.

12. A communication system, comprising:
a hearing aid; and
a communication device, said hearing aid and said communication device are configured in combination to carry out the method according to claim 1.
